(19) United States
(12) Patent Application Publication
(10) Pub. No.: US 2008/0050614 A1
(43) Pub. Date: Feb. 28, 2008

(54) AL2O3 multilayer plate

(76) Inventor: Helga Holzschuh, Mehrstetten (DE)

Correspondence Address: RONALD S. LOMBARD;PATENTS AND TRADEMARKS, 4430 TWIN OAKS DRIVE, MURRYSVILLE, PA, 15668, US

(21) Appl. No.: 11/821,906

(22) Filed: Jun. 26, 2007

Related U.S. Application Data
(63) Continuation-in-part of application No. PCT/EP05/12611, filed on Nov. 25, 2005.

(30) Foreign Application Priority Data
Dec. 30, 2004 (DE) 10 2004 063 816.0

(51) Int. Cl. B32B 9/00

(52) U.S. Cl. 428/698; 428/699; 428/701

(57) ABSTRACT

The layer structure of a cutting plate produced according to a chemical vapor deposition CVD method contains a thick outer covering layer of medium temperature (MT) TiCN, and a multilayer Al₂O₃ layer arranged beneath the covering layer. Said multilayer Al₂O₃ layer consists of, at least, two aluminum oxide layers between which TiCN layers, and optionally TiAlC—NO layers for improving adhesion, are arranged. One such overall design has especially good chip removal properties.

### CROSS-REFERENCE TO RELATED APPLICATION

This is a continuation-in-part application of international application PCT/EP2005/012611 filed Nov. 25, 2005 and claiming the priority of German application 10 2004 063 816.0 filed Dec. 30, 2004.

### BACKGROUND OF THE INVENTION

This invention resides in a cutting plate with a wear resistant coating or a cutting tool with such a wear resistant coating.

Of today's cutting tools, a long service life and toughness is expected. These requirements result from the need of cutting particularly hard or tough materials and also because of a desired increase of the cutting speed. As wear reducing coatings, particularly for the cutting of steels, aluminum oxide layers have been found to be very suitable. However, it is increasingly found that the toughness of the cutting plates and their resistance to various types of wear depends not only on the material composition of the used wear reducing coatings, but also on the layer sequence and particularly on the thickness of the used layers and their adhesion or, respectively the adhesion of the individual layers.

In this regard EP 134 8779 A1 discloses, for example, a wear reducing coating which includes an aluminum oxide layer which is embedded between TiCN layers. While the thickness of the whole set-up does not exceed 30 μm, it is further envisioned that the aluminum oxide layer is one to three times as thick as the TiCN layer disposed below and that the top TiCN layer is 0.1 to 1.2 times the thickness of the two layers disposed below, combined. It is said that with this layer set-up, good cutting results are obtained.

U.S. Pat. No. 6,221,479 B1 attempts to improve the cutting properties of cutting plates by improving the composition of the base body.

DE 101 23 554 A1 on the other hand proposed a method for increasing the compression tensions or for reducing the tensile stresses in an outer layer of a wear-reducing coating: The coating is subjected to a radiation treatment wherein, for example, a zirconium oxide granulate, pressure-sprayed steel powder or a sintered hard metal spray granulate is dry-sprayed onto the surface to be treated. The procedure results in a surface smoothing and a reduction of internal tensile stresses or the generation of compression tensions in the coating.

EP 0727509 B1 discloses a cutting plate with a multi-layer κ-Al₂O₃ coating including six to eight Al₂O₃-layers. Under the κ-Al₂O₃ layers a TiN— or TiCN-layer is disposed as a so-called intermediate layer. Between the κ-Al₂O₃ layers there is in each case a modification layer consisting of a (Alₓ—Ti_{y}) (O_{w}C₂Nᵤ) layer with ₓ and _{y}=2 - - - 4 for improving the attachment of the κ-Al₂O₃ layers to the respective under laying κ-Al₂O₃ layer. The κ-Al₂O₃ multi layer coating is disposed on a base layer, for example of TiCN. Based hereon, it is the object of the invention to further improve a corresponding cutting plate and, respectively, a cutting tool.

### SUMMARY OF THE INVENTION

The layer structure of a cutting plate produced according to a chemical vapor deposition (CVD) method contains a thick outer covering layer of a medium temperature (MT) TiCN, and a multilayer Al₂O₃ layer arranged beneath the covering layer. Said multilayer Al₂O₃ layer consists of, at least, two aluminum oxide layers between which TiCN layers, and optionally TiAlC—NO layers for improving adhesion, are arranged. One such overall design has especially good chip removal properties.

The cutting plate or, respectively, the cutting tool according to the invention is provided with a wear-reducing coating which includes at the bottom a first single or multi-layer layer comprising at least one layer of nitrides, carbides, carbonitrides or oxicarbonitrides, boronitrides, borocarbonitrides, borocarbooxinitrides of metals of the fourth or the fifth or the sixth subgroup or a combination of those compounds. Disposed, thereon, is a second layer of Al₂O₃ multi-layers. On top of this layer, a cover layer is provided which consists of nitrides, carbides, carbooxinitrides or carbonitrides of Ti, Zr or Hf or a combination of these layers and whose thickness is preferably greater than 3 um. This combination has been found to be superior for cutting procedures. This is particularly true for cutting steel and in connection with interrupted cuts. While the Al₂O₃ layer, as such, is heat insulating and reduces the cavitation wear, the arrangement of a multilayer coating is advantageous particularly because of the concurrent reduction of the internal tensions. This is advantageous in an uninterrupted cut. The generously dimensioned cover layer which consists of at least two coatings of the group of nitrides, carbides, carbooxonitrides or carbonitrides of Ti, Zr or Hf or a combination of these layers provides at the same time for a high abrasion wear resistance. The cover layer is preferably a MT-TiCN layer and is substantially thicker than any Al₂O₃ layer underneath. It is preferably thicker by a factor of 1.5 to 2 than the individual Al₂O₃ layer.

The individual Al₂O₃ layers have a thickness of 0.5 μm to 4 μm, preferably 2 μm. They are deposited by a chemical vapor deposition, CVD-process. The intermediate layers are preferably combined TiCN—TiCNO-layers, wherein, for improving the connection between this TiCN—TiCNO layers and the Al₂O₃ layers, TiAlCNO intermediate anchoring layers may be provided. These layers preferably include a phase mixture of TiCN and Al₂TiO₅ (Pseudo-Brookit-structure). A particularly good connection is achieved by limiting the aluminum content to at most 4 at %. It has been formed in this connection that in particular the layer arrangement Al₂O₃—TiCN—TiCNO—TiAlCNO —Al₂O₃ is suitable. To the Al₂O₃ layer, a TiCN layer can be directly applied. No intermediate anchoring layer is necessary.

With the special intermediate layer arrangement, particularly with the use of a TiCN layer overall a very low individual layer tension and a low wear during interrupted cutting and also a high abrasion resistance are achieved. For example, the TiNCN intermediate layer has an individual layer tension of only 100 to 150 MPa. This is a substantial improvement, for example, in comparison with TiN intermediate layers which have an individual layer tension of 200 to 300 MPa and provides, overall, for a reduction of the individual layer tension of the multi-layer coating. With a possibly smooth transition to oxidation layers (TiCNO) and possibly additionally aluminum containing layers (TiAlCNO) the connections of the Al₂O₃ layers in the multi-layer buildup are substantially improved.

The intermediate layers have preferably a layer thickness of between 0.2 μm and 2 μm. Preferably the thickness is 1.0 μm. The intermediate connecting layers have a thickness of 0.1 to 0.7 μm, preferably 0.5 μm. An Al₂O₃ multi-layer coating built-up in this way, particularly in connection with the cover layer of more than 3 μm provides for the cutting plate very good wear properties. The Al₂O₃ multi-layer coating is preferably applied to a base layer (TiCN-layer). For the connection, again a TiCNO-layer and a TiAlCNO anchoring layer may be used, whose aluminum content is preferably below 4 at %. The anchoring layer has a thickness of, for example, only 0.5 μm. Preferably the base layer then has a multi-layer built-up with a layer structure from the outside to the inside as follows:
6) HT—TiAlCNO
5) HT—TiCNO
4) HT—Ti(CₓN_{y}), (carbon rich), X>0.5
3) HT—Ti(CₓN_{y}), (nitrogen rich), Y>0.5
2) MT—TiCN
1) MT—TiN
   Herein “HT” indicates a high temperature—CVD process (over 950° C. process temperature) and MT indicates a Medium Temperature—CVD process (below 950° C. processing temperature).

This whole layer arrangement can be produced with the CVD process. The special feature of this layer arrangement is the fact that the individual stresses of the intermediate layers and also of the Al₂O₃ and the cover layer after this first Al₂O₃ layer are substantially reduced. This explains the low sum of the individual stresses of this multi-layer coating. The individual stresses are herein generally positive, that is, they are tensile stresses. In a particularly preferred embodiment, those stresses are at least on the area of the surface converted to compression stresses. To this end, an additional layer, for example, a TiN outer layer is applied to the outer TiCN layer and at least sections of this additional layer is then again removed. The removal of this additional layer can be accomplished by an abrasive method, for example, a wet jet process. This generates in the cover layer, at least on the outer area thereof, high compressive stresses and an increase of the hardness of the surface area which greatly reduces the fracture susceptibility, particularly the ridge fracture sensitivity, of the layer.

In addition to the layer dependency of the individual stresses, the layers have, depending on their position in thee overall system of the layer setup, different preferential orientations.

### BRIEF DESCRIPTION OF THE DRAWINGS

Further, advantageous features of embodiments of the invention are apparent from the drawings or the description. The drawings show a particular embodiment of the invention in which:

FIG. 1 is a schematic of the layer arrangement of a coating according to the invention of an improved cutting plate in a schematic representation; and,

FIG. 2 a graph showing stresses in the outer layer structure (last Al₂O₃-layer and cover layer) before and after the removal of the outer TiN-layer.

### DESCRIPTION OF THE ADVANTAGEOUS EMBODIMENTS

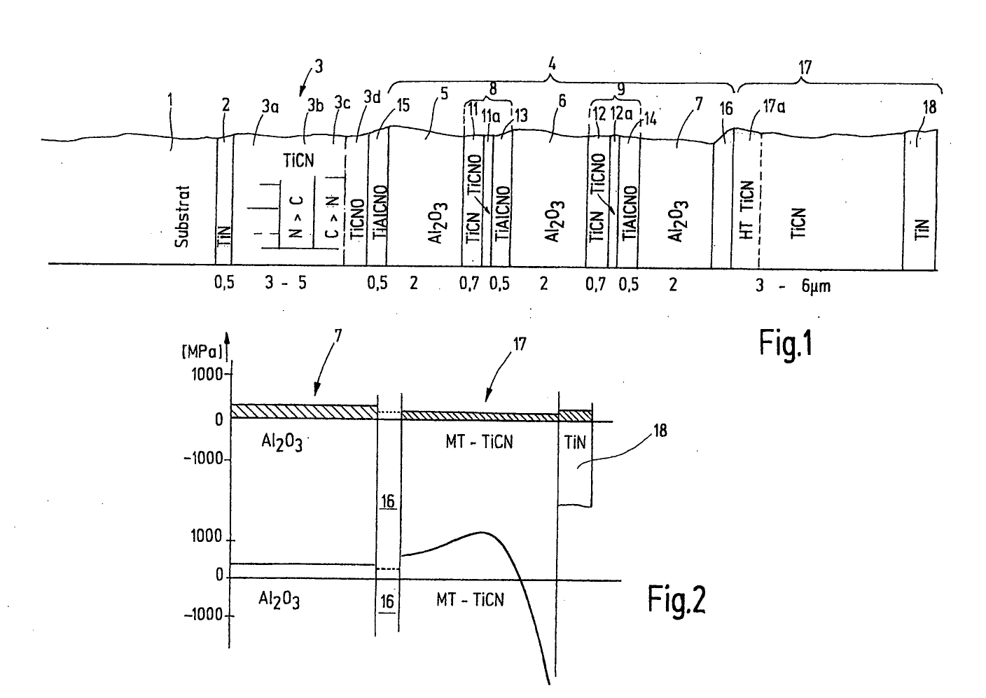

FIG. 1 shows the layer arrangement of a cutting plate according to the invention or of a cutting tool. It comprises a base body 1 which is indicated in FIG. 1 as Substrate. To this substrate, in a chemical vapor deposition CVD process, a base layer 2 consisting of TiN is applied. The layer has a thickness of about 1 μm, preferably less, for example, 0.5 μm. On this base layer 2, a first layer 3 consisting of several TiCN part layers 3a, 3b, 3c (actually Ti(CₓN_{y}), partial layers) and a TiCNO layer 3d are deposited. The first part layer 3a is applied at relatively moderate temperatures of, for example, less than 950° C. The part layer 3a is therefore also designated as MT-TiCN layer and has a column-like structure. Next is a nitrogen rich polycrystalline TiCN part layer 3b (Ti(CₓN_{y})₁, Y>0.5. This layer may be effective as a diffusion blocker. Then follows the other carbon-rich TiCN part layer 3c (Ti(CₓN_{y})₁, X>0.5 which has a partially needle-like crystal structure and which is also applied at higher temperature. On the TiCNO layer 3d, which also has a needle-like crystal structure, additional layers may be deposited, for example, a TiAlCNO-layer 15 providing for an improved connection of subsequent Al₂O₃ layers. This layer may have a thickness of 0.2 μm to 1.0 μm. The first layer 3 overall has a column-like structure wherein the individual columns have, on average, a width of 0.5 to 0.3 μm (as measured during a coating experiment with 10 μm layer thickness). The layer, therefore, has five columns. The columns extend normal to the individual layers, that is, they are oriented in FIG. 1 horizontally. The layer 15 has a needle or platelet structure for improved mechanical connection of the Al₂O₃ layer. The above described complicated layer built up, limits the diffusion of compounds out of the hard metal into the layers and improves the layer connection of the wear reducing coating.

To this TiCN lays an Al₂O₃ multi-layer 4 is applied whose overall thickness is preferably between 8 μm and 10 μm. It has at least two, preferably, however, several (preferably not more than five) individual layers. Included therein are Al₂O₃ layers 5, 6, 7, which each have a thickness of about 2 μm. The Al₂O₃ layers are, for example, κ-Al₂O₃ layers. This provides for a good heat insulation by the Al₂O₃ layers and a good thermal load carrying capacity which is advantageous in connection with the machining of steel. However, the Al₂O₃ layers may also be α-Al₂O₃ layer. These layers have a higher heat conductivity and are stable also at high temperatures. They can provide better results in connection with cast iron machining. It is also provided to combine α-Al₂O₃ layers and κ-Al₂O₃-layers. For example, alternately one or several α-Al₂O₃ layers And one or several κ-Al₂O₃ layers may be provided. It is also possible to deposit one or several κ-Al₂O₃ layers on one or several α-Al₂O₃ layers. In this case, the κ-Al₂O₃ layers form a thermal barrier which thermally protects the α-Al₂O₃ layers.

Between the Al₂O₃ layers 5, 6, 7 intermediate layers 8, 9 are formed. They consist each at least of a TiCN layer 11, 12 and a TiCNO layer 11a, 12a. In addition, they may contain a TiAlCNO layer 13, 14. The overall thickness of the intermediate layers 8, 9 is preferably between 0.5 and 1.5 μm. The TiCN layers 11, 12 have, in connection with the TiCNO layers 11a, 12a each a thickness of about 0.7 μm whereas the TiAlCNO intermediate anchoring layer 13, 14 disposed thereon each has a thickness of 0.5 μm. The intermediate anchoring layers 13, 14 serves, in connection with the TiCNO layer 11a, 12a disposed underneath, for the attachment of the Al₂O₃ layer 6, 7 to the TiCN layer 11, 12 disposed therebelow.

Between the Al₂O₃ layer 5 and the first layer 3, there may also be a TiAlCNO layer with a thickness of 0.5 μm which forms an anchoring layer 15.

The whole Al₂O₃ multi-layer coating is deposited by a CVD process. Because of the multi-layer arrangement with low individual stresses, the overall layer stresses are also low.

On the Al₂O₃ multi-layer 4, a cover layer 17 is deposited possibly by means of a suitable connecting layer 16 (for example TiCNO or TiAlCNO). The cover layer 17 comprises different TiCN Layers with different C/N ratio and microstructure and a TiN layer. The TiCN layers consist mostly of a MT-layer and have an overall thickness of 3 μm to 6 μm. It has a column-like-structure with columns which are oriented normal to the layer plane. The columns are relatively wide. For columns a width in the range of 0.4 to 0.5 μm in a layer thickness of 6 μm is preferred. Below the MT-TiCN-layer a HT-TiCN layer 17a is provided. All together the individual layer stresses, as shown in FIG. 2 exist. The Al₂O₃ layer 7, as well as the MT-TiCN layer 17 are subjected to low tensile stresses.

Although the cutting plate has in this configuration already an excellent machining performance, particularly in the machining of cast iron and steel with interrupted cuts, the performance of the cutting plate can still be improved by the application of the TiN layer 18 and its subsequent complete or partial (in particular mechanical) removal in a follow-up treatment. The stress curve obtained thereby is shown in FIG. 2 at the bottom. The MT-TiCN layer provides for high compressive stresses in the outer area. These compressive stresses can reach up to and unto the Al₂O₃ layers depending on the mechanical procedure used for the layer removal. In the preferred embodiment, the compressive stresses remain in the MT-TiCN layer. The introduced compressive tensions are neutralized preferably within the TiCN layer, that is, this layer is subjected at the outside to high compressive stresses and on the inside to slightly increased tensile stresses.

Simply by local removal of the TiN-layer 18, for example, at the true sake of the cutting plate, two-colored cutting plates can be produced. The TiN layer has a color different from that of the TiCN layer.

In the embodiment described, the following tensile stresses can develop:
First, MT-layer, layer (3): +612 MPa
Second, MT-layer, cover layer (17): +202 MPa
First Al₂O₃-layer (5): +667 MPa
HT-TiCN—intermediate layers: +100 - - - 150 MPa
Third, Al₂O₃-layer (7): +343 MPa.
   With the layer arrangement as shown, the multi-layer Al₂O₃ coating can be produced with low individual tensile stresses (of, for example, only about 200 MPa) can be produced. Low individual stresses are considered to be advantageous with regard to cutting properties. Also, the outer Al₂O₃ layers 6, 7 have lower individual stresses than the base layer 3 or the inner Al₂O₃ layer 5. This results in an advantageous state for the overall arrangement as far as stresses are concerned—with low individual stresses in the cover layer as well as in the multi-layer—Al₂O₃ coating.

For performing a cutting test conventional cutting plates with single-layer Al₂O₃ coating and thick TiCN cover layers and also cutting plates with single layer Al₂O₃ coating and thin TiN cover layer were compared with a cutting plate according to the invention with the coating structure described herein. In comparison with the conventional cutting plates and also in comparison with a single layer aluminum oxide coating and a TiCN cover layer, a substantial service life increase for steel cutting with a continuously smooth cut was achieved. The improvement of the individual stress conditions of the cutting plate according to the invention are even more clearly apparent from the interrupted cutting test (sharp milling test) with a reduction of the variations in the service life results.

The layer arrangement of a cutting plate produced by a CVD process includes a thick outer cover layer 17 of MT-TiCN and a multi-layer Al₂O₃-layer disposed beneath and also a first layer of TiN and MT-TiCN. The multi-layer Al₂O₃ coating consists of two, three or several aluminum oxide layers, between which TiCN layers and possibly, for improving the connection, TiCNO and TiAlCNO-layers are arranged. Such an overall construction has particularly good machining properties.

What is claimed is:

1. A cutting plate for a cutting tool or a cutting tool, comprising a wear reducing coating containing:
a multi-layer base coat (2, 3) comprising at least nitrides, carbides, carbonitrides and at least one oxicarbonitride, boronitride, borocarbonitride, borocarbooxinitride or an aluminum-containing oxicarbonitride of metals of the fourth and/or fifth and/or sixth subgroup or a combination of these compounds;
an Al₂O₃ multi-layer coating (4), consisting of Al₂O₃-layers (5, 6, 7) and intermediate layers (8, 9), said intermediate layers (8, 9) each contain at least one TiCN layer (11, 12) and said intermediate layers (8, 9) each contain at least one TiCNO layer (11a, 12a) and said intermediate layers (8, 9) disposed between the Al₂O₃ layers (5, 6, 7); and,
an at least two-layer cover coating (17) consisting of nitrides, carbides, carbooxonitrides or carbonitrides of Ti, Zr or Hf or a combination of these layers and said at least two-layer cover coating (17) having a thickness of more than 3 μm.

2. A cutting plate or cutting tool according to claim 1, wherein the Al₂O₃ layers (5, 6, 7) have a thickness of 0.5 μm to 4 μm, preferably 1 μm to 3 μm.

3. A cutting plate or cutting tool according to claim 1, wherein the cover layer (17) has a thickness of 1.5 to 2 times that of an Al₂O₃ layer (5, 6, 7).

4. A cutting plate or cutting tool according to claim 1, wherein the Al₂O₃ layers (5, 6, 7) have a thickness of 2 μm.

5. A cutting plate or cutting tool according to claim 1, wherein the TiCN layers (11, 12) of the intermediate layers (8, 9) are polycrystalline layers.

6. A cutting plate or cutting tool according to claim 1, wherein the intermediate layers (8, 9) include, in addition to at least one TiCN layer (11, 12) and at least one TiCNO-layer (11a, 12a), at least one TiAlCNO intermediate anchoring layer (13, 14) which contains at most 4% aluminum.

7. A cutting plate or cutting tool according to claim 1, wherein the intermediate layer (8, 9) has a layer thickness of 0.2 μm to 2 μm, preferably 0.5 to 1.5 μm.

8. A cutting plate or cutting tool according to claim 1, wherein the intermediate layer (8, 9) has a thickness of 1 μm.

9. A cutting plate or cutting tool according to claim 6, wherein the TiAlCNO intermediate anchoring layer (13, 14) has a thickness of 0.1 to 0.7 μm.

10. A cutting plate or cutting tool according to claim 1, wherein the Al₂O₃ multi-layer coating (4) is disposed on a TiAlCNO anchoring layer (15) containing at most 4 at % aluminum.

11. A cutting plate or cutting tool according to claim 10, wherein the TiAlCNO anchoring layer (15) has a thickness of 0.2 μm to 1.0 μm.

12. A cutting plate or cutting tool according to claim 11, wherein the TiAlCNO anchoring layer (15) has a thickness of 0.5 μm.

13. A cutting plate or cutting tool according to claim 1, wherein the base layer (3) below the TiAlCNO anchoring layer (15) the base layer (3) is partially in the form of a five-column MT-TiCN layer (3) with a column width of 0.1 μm to 0.5 μm.

14. A cutting plate or cutting tool according to claim 1, wherein the base layer (3) comprises, starting with the substrate toward the Al₂O₃ multi-layer (4) comprises the following arrangement:
1) MT—TiN—layer (2)
2) MT—TiCN—layer (3a)
3) HT—Ti(cₓN_{y})—layer (3b) (nitrogen rich), Y>0.5
4) HT—Ti(CₓN_{y})—layer (3c) (carbon rich), X>0.5
5) HT—TiCNO—layer (3d)
6) HT—TiAlCNO

15. A cutting plate or cutting tool according to claim 1, wherein the cover layer (17) has a thickness of at least 5 μm.

16. A cutting plate or cutting tool according to claim 1, wherein the cover layer (17) has a column-like-structure with a column width of 0.4-0.5 μm.

17. A cutting plate or cutting tool according to claim 1, wherein the whole said wear reducing coating has a layer construction formed by the chemical vapor deposition CVD process.

18. A cutting plate or cutting tool according to claim 1, wherein the cover layer (17) is subjected in an outer area thereof to compressive stresses.

19. A cutting plate or cutting tool according to claim 1, wherein the cover layer (17) is provided, at least in sections, with an outer layer (18) and that the cover layer (17) has zones in which the outer layer has been removed, after its application, by an abrasive method.

20. A cutting plate or cutting tool according to claim 1, wherein at least one of the Al₂O₃ layers is a κ-Al₂O₃ layer.

21. A cutting plate or cutting tool according to claim 1, wherein at least one of the Al₂O₃ layers is an α-Al₂O₃ layer.

22. A cutting plate or cutting tool according to claim 1, wherein the cover layer (17) is subjected to tensile stresses which are at least 50% lower than the individual tensile stresses in the base layer (3)

23. A cutting plate or cutting tool according to claim 1, characterized in that the outer Al₂O₃ layer (7) is subjected to individual tensile stresses which are lower, by at least one third, than the individual tensile stresses of the inner Al₂O₃ layer.
